(19) United States
(12) Patent Application Publication
(10) Pub. No.: US 2013/0298803 A1
(43) Pub. Date: Nov. 14, 2013

(54) AQUEOUS CARBON BLACK FORMULATIONS FOR INK JET

(71) Applicant: LANXESS Deutschland GmbH, Leverkusen (DE)

(72) Inventors: Thomas SOMMERMANN, Bergisch Gladbach (DE); Udo HERRMANN, Dormagen (DE)

(73) Assignee: LANXESS Deutschland GmbH, Leverkusen (DE)

(21) Appl. No.: 13/947,587

(22) Filed: Jul. 22, 2013

Related U.S. Application Data
(62) Division of application No. 12/299,796, filed on Feb. 13, 2009.

(30) Foreign Application Priority Data
May 13, 2006 (DE) 10 2006 022 450.7

(51) Int. Cl. C08K 5/3465

(52) U.S. Cl. CPC C08K 5/3465
USPC 106/476

(57) ABSTRACT

Aqueous carbon black formulation containing a) at least one carbon black and b) at least one neutralized sulphation product of the reaction product of nitrobenzene and aniline in the presence of iron (II) chloride.

The invention relates to aqueous carbon black formulations, inks based thereon, process for their production and their use for printing sheetlike or three-dimensional substrates using ink jet processes.

Carbon black used as a black pigment offers significantly higher ozone and light resistance than dye mixtures. However, impeccable dispersion of the pigment particles is an absolute condition for trouble-free use and for stable storage. Printability on different printers has to be ensured by setting a suitable viscosity, and start-of-print performance likewise needs to be impeccable.

A further important point is compatibility with water-soluble solvents which are generally co-included in ink-finishing systems to prevent flocculation.

U.S. Pat. No. 5,085,698 and U.S. Pat. No. 5,320,668 were the first patents to address the use of pigment carbon blacks in ink jet inks. They describe the use of water-soluble acrylates as dispersants.

Other dispersant systems consist of a mixture of functionalized polyether-polyols and condensed arylsulfonic acids as described in DE 19 801 759 A1.

These dispersions are partly sensitive to water-soluble solvents which can likewise adsorb onto the pigment. These include for example alkyl polyglycol ethers having alkyl radicals >2 carbon atoms and <8 carbon atoms, the polyethylene glycol radical comprising 1 to 6 ethylene glycol units or 1-3 propylene glycol units.

A further approach is to functionalize the pigments with dispersing groups, as in U.S. Pat. No. 5,554,739 and U.S. Pat. No. 5,922,118 for example. However, these solvent-stable dispersions have the disadvantage of an increased tendency to migrate and the associated lower water fastness.

It has now been found that, surprisingly, a carbon black dispersion containing a specific sulphonated black condensation dye overcomes these disadvantages.

The invention accordingly provides aqueous carbon black formulations containing

a) at least one carbon black and

b) at least one neutralized sulphation product of the reaction product of nitrobenzene and aniline in the presence of iron(II) chloride.

Preferred carbon blacks for component a) are types having a pH of <4.5 in a 5% aqueous slurry, such as Spezialschwarz® 4, Spezialschwarz® 4a, Spezialschwarz® 5, Spezialschwarz® 6, Spezialschwarz® 100, Spezialschwarz® 250, Spezialschwarz® 350 or Spezialschwarz® 550 from Degussa and also pigment grade carbon blacks of the types FW 200, FW 2, W 2V, FW 285, FW 1, FW 18, S 160, S 170 or of the Printex types V, 140U from Degussa.

Component b) shall herein be referred to as Acid Black 2.

The degree of sulphation of Acid Black 2 is preferably in the range from 15% to 25% by weight.

The reaction of nitrobenzene and aniline is preferably carried out at a temperature in the range from 170 to 190° C. in the presence of iron(II) chloride, in particular during 10 to 20 hours.

The sulphation is preferably effected using sulphating agents such as sulphuric acid, oleum, chlorosulphonic acid, amidosulphonic acid or SO₃. Preference is given to 96% sulphuric acid, in particular at a temperature of 95-97° C., or 5-30% oleum, in particular at a temperature of 0-20° C. and preferably at 8-12° C.

For example, a sulphation with 96% sulphuric acid preferably takes 0.5-3 h, in particular 1-1.5 hours, while a sulphation with 20% oleum preferably takes 12 hours. The sulphation product thus obtained is then neutralized.

Neutralization is preferably carried out using lithium hydroxide, sodium hydroxide, potassium hydroxide, ammonium hydroxide and also water-soluble amines such as ethanolamine, diethanolamine, triethanolamine, methyldiethanolamine, N,N′-dimethylaminoethanol, propanolamine, butanolamine or aminoethylpropanolamine.

The carbon black formulation of the present invention is preferably a carbon black dispersion.

The carbon black formulation of the present invention is preferably characterized in that the formulation consists of more than 90% by weight, preferably more than 95% by weight and in particular more than 99% by weight of components a), b) and aqueous medium.

The aqueous medium is preferably present in an amount of 1% to 88% and in particular of 5-60% by weight, based on the formulation. The aqueous medium is either water alone or a mixture of water with organic solvents, these organic solvents preferably having a water-solubility of more than 5 g/l at 20° C.

The carbon black formulation of the present invention comprises preferably less than 0.5% by weight and in particular less than 0.2% by weight of salt, based on the formulation.

The carbon black formulation preferably contains 3-50% by weight and in particular 5% to 45% by weight of component a).

It is preferable to use 5-35% by weight and in particular 8-25% by weight of component b), based on the formulation.

Useful organic solvents include:

Aliphatic C₁-C₄ alcohols, linear or branched, pentanediol, aliphatic ketones such as acetone, methyl ethyl ketone, diacetone alcohol, polyols such as ethylene glycol, diethylene glycol, triethylene glycol, polyglycols having a molar mass of 200-2000 g/mol, propylene glycol, dipropylene glycol, tripropylene glycol, trimethylolpropane, glycerol, thiodiglycol, 2-pyrrolidone, N-methylpyrrolidone, N-ethylpyrrolidone, 1,3-dimethylimidazolidinone, dimethylacetamide and also dimethylformamide.

Mixtures of the solvents mentioned are also contemplated.

The amount of organic solvent is preferably 0-50% by weight and in particular 0-35% by weight. The pigment formulation may further comprise agents for setting the viscosity, for example polyvinyl alcohol, polyvinylpyrrolidone, methylcellulose, xanthans, provided they have no adverse effect on stability, printing performance and drying performance on paper.

To set the pH, the pigment formulation may contain pH regulators such as NaOH, KOH, aminoethanol, aminomethylpropanol, triethanolamine, N,N-dimethylaminoethanol, diethanolamine or methyldiethanolamine.

The carbon black formulation may further be freed of coarse particles, preferably by means of a 1-10 μm membrane or of a glass filter.

The invention further provides a process for producing carbon black formulations according to Claim 1, characterized in that components a) and b) are conjointly homogenized in an aqueous medium, preferably water.

To homogenize the formulation, the individual components are preferably beaten up in a dissolver and subsequently ground in a high energy bead mill using zirconium oxide beads for example.

The formulation is generally filtered thereafter, for example through 1-10 μm membrane or glass fibre filters.

The pigment formulations of the present invention exhibit excellent stability in storage and provide print of high optical density and excellent crispness both on thermal bubble jet printers (HP, Canon, Encad) and piezo printers (Epson, Mutoh).

The invention further provides aqueous inks, i.e. present invention carbon black formulations containing at least one solvent described above. The inks of the present invention preferably contain less than 10% by weight and in particular less than 6% by weight of components a) and b).

The invention further provides for the use of the present invention's carbon black formulations or inks for printing sheetlike or three-dimensional substrates using ink jet processes.

Table 1 shows the constancy of the optical densities on various papers and using various amounts of Acid Black 2.

The optical density of the prints was determined with measuring instrument from QEA=Quality Engineering Associates Inc.

### EXAMPLES

### Preparation of Acid Black 2

### a) Reaction Product of Nitrobenzene and Aniline

Nitrobenzene (12 mol), aniline (17 mol) and iron(II) chloride (2 mol) are reacted at about 180° C. for 16 h. The solution of nigrosine melt in an excess of aniline is then poured onto dilute aqueous sodium hydroxide solution and stirred in. The aqueous phase takes up the iron salts; the nigrosine base is recovered from the organic phase by distillative removal and drying. The solid thus recovered is hereinbelow referred to as Solvent Black 7.

### b) Sulphation

A 50 l stirred vessel is charged with 16.3 l of 96% sulphuric acid. 10 kg of Solvent Black 7 are added a little at a time with stirring.

The temperature is maintained at 90° C. until everything has dissolved.

A dilution vessel is charged with 185 l of completely ion-free water and the reaction mixture is added such that the temperature is 70-80° C. The product is isolated on a filter press (crude nigrosine).

26 kg of water and 1.85 l of 50% aqueous sodium hydroxide solution are introduced into a stirred vessel and admixed with 33.3 kg of crude nigrosine by stirring. The solution thus obtained contains Acid Black 2.

### c) Purification of Acid Black 2

The solution is filtered through a 25 μm filter.

This solution is adjusted to the desired concentration with completely ion-free water and is desalted in a pressure permeation system to a salt content of less than 0.5%. This nigrosine is used as a dispersant in the examples which follow.

### Base Liquid for Printing Tests Using Pigment Inks:

15% of 1.5-pentanedial

10% of polyethylene glycol 200

5% of 2-pyrrolidone

70% of completely ion-free water

The homogenized carbon black dispersions are adjusted to a pigment content of 5% by diluting with the base liquid and are then printed up.

### Example 1

TABLE 1
OD = optical density

| Carbon black | Acid | | OD on |
|---|---|---|---|
| content* | Black 2** | OD on HP Bright white*** | HP Premium**** |
| 18% | 2% | 1.5 | 1.63 |
| 18% | 3% | 1.5 | 1.63 |
| 18% | 4% | 1.5 | 1.63 |

*based on carbon black dispersion
**based on carbon black dispersion
***80 g/m² paper from HP
****100 g/m² paper one side surface-coated from HP

The inks produced from the carbon black dispersions of the present invention were printed up using an HP 6122 ink jet printer.

### Example 2

A 20 litre vessel is charged with 1 l 990 g of completely ion-free water, 2660 g of the Acid Black 2 solution obtained according to the above prescription c), having a solids content of 30.0%, and 300 g of ethanolamine. This mixture is homogenized with a dissolver for 15 minutes. 5000 g of Spezialschwarz S4 carbon black (Degussa) are added a little at a time with stirring.

This dispersion is circuit ground on a Drais V-15 bead mill for 7 hours, the flow rate being 260 kg/hour. Bead diameter is between 0.7 and 0.9 mm. The product is filtered through 10 μm plate filters.

The base liquid is used to produce an ink ham 5% pigment content, which is printed up on 180 g/m² premium paper using an Encad Novajet® 700. The optical density is found to be 1.6.

### Example 3

In a 5 litre vessel, 2570 g of completely ion-free water, 400 g of Acid Black 2 solution obtained according to the above prescription c) and having a solids content of 30% and 30 g of ethanolamine are beaten up and homogenized with a dissolver. 750 g of Farbruβ FW2 carbon black from Degussa are added a little at a time with stirring.

This dispersion is ground on a Drais V-15 bead rate of 150 l/h for 1.5 hours an finally filtered through 1.2 μm.

The base liquid is used to produce an ink having a 5% pigment content which is printed up on an Epson C-82.

HP Bright white paper gives an optical density of 1.4.

HP Premium paper gives an optical density of 1.45.

### Example 4

In a 5 litre vessel, 1818 g of completely ion-free water, 400 g of Acid Black 2 solution obtained according to the above prescription c) and having a solids content of 30% and 30 g of ethanolamine are beaten up and homogenized with a dissolver. 750 g of Spezialruβ S 6 carbon black are added a little at a time with stirring.

This dispersion is ground en a Drais V-15 bead mill at a flow rate of 150 l/h for 2 hours and finally filtered through 1.2 μm.

The base liquid is used to produce having a 5% pigment content which is printed up on an HP Deskjet® 1280.

HP Bright white paper gives an optical density of 1.32.

HP Premium paper gives an optical density of 1.5.

What is claimed is:

1. A process for producing an aqueous carbon black formulation comprising:
conjointly homogenizing in an aqueous medium:
a) at least one carbon black; and
b) at least one neutralized sulphation product comprising the reaction product of nitrobenzene and aniline in the presence of iron(II) chloride.

2. The process according to claim 1, further comprising beating up components a) and b) in a dissolver and subsequently grinding them in a high energy bead mill.

3. The process according to claim 1, wherein part a) is present in an amount of 3% to 50% by weight based on the total weight of components a) and b).

4. The process according to claim 1, wherein part b) is present in an amount of 5% to 35% by weight based on the total weight of components a) and b).

5. A process for producing an aqueous carbon black formulation comprising:
conjointly homogenizing in an aqueous medium:
a) at least one carbon black; and
b) at least one neutralized sulphation product comprising the reaction product of nitrobenzene and aniline in the presence of iron(II) chloride;
wherein said homenginization comprises beating up components a) and b) in a dissolver and subsequently grinding them in a high energy bead mill.
